(19) United States
(12) Patent Application Publication
(10) Pub. No.: US 2026/0270519 A1
(43) Pub. Date: Sep. 10, 2026

(54) Video Information Display Device

(71) Applicants: Masahide Tanaka, Osaka (JP); Osamu Fujiyasu, Osaka (JP); Mitsuo Furukawa, Osaka (JP)

(72) Inventors: Masahide Tanaka, Osaka (JP); Osamu Fujiyasu, Osaka (JP); Mitsuo Furukawa, Osaka (JP)

(73) Assignee: NL Giken Incorporated, Osaka (JP)

(21) Appl. No.: 19/559,955

(22) Filed: Mar. 7, 2026

(30) Foreign Application Priority Data
Mar. 7, 2025 (JP) 2025-036882
Mar. 5, 2026 (JP) 2026-035185

(51) Int. Cl. H04N 21/472; H04N 21/442; H04N 21/466; H04N 21/6587

(52) U.S. Cl. CPC H04N 21/47217; H04N 21/44218; H04N 21/4666; H04N 21/6587

(57) ABSTRACT

Video information display device controls playback based on feedback of feeling of the viewer determined by its facial expressions or voice tone of the viewer viewing the video. Based on the feedback, video playback is so controlled to either promote or counteract the feeling of the viewer. If no feeling reaction is detected, the playback leads the viewer to elicit a reaction. The playback control is done to steer the emotion of the viewer towards pleasantness. Each video is assigned information such as association information with other videos, original image information from which the video originated, personal identification information, feeling information regarding the video content, viewer reaction history information, and prompt information for video generative AI. Control is performed by a generative AI that functions based on the words, voice tone, and facial expressions of the viewer. AI modifies its response generation in response to the feedback information.

### BACKGROUND OF THE INVENTION

### 1. Field of the Invention

The present invention relates to a video information display device.

### 2. Description of the Related Art

The most common type of video information display device is a television. In addition to displaying regular broadcasts, it is also used to display various image information desired by the user, which is input from an external source onto its display screen. Furthermore, devices specialized for displaying image information, such as electronic photo frames or digital photo frames, have been proposed in various forms. These devices also download and display image information via communication functions. Japanese Publication No. 2012-104071, for example, includes disclosure about digital photo frame.

Furthermore, in the electronic photo frames or digital photo frames, it has been proposed that the display mode of images be changed based on the number of users detected by a user detection sensor and the results of user authentication for displaying appropriate image information to the user such as disclosed in Japanese Publication No. 2010-016432.

Additionally, electronic photo frames or digital photo frames capable of displaying video have also been proposed such as in Japanese Publication No. 2011-205382

On the other hand, services that create videos based on still images as video information for display have also been proposed such as Japanese Publication No. in 2011-082789.

However, challenges remain to be addressed in image display devices to provide image displays tailored to users.

### SUMMARY OF THE INVENTION

In view of the above, the problem to be solved by the present invention is to propose a user-friendly video information display device that can better respond to users.

To solve the above problem, the present invention provides a video information display device comprising a storage unit for video information, a control unit for controlling playback of the video information in the storage unit; a display for displaying the video information based on the control unit, and feedback acquisition unit for acquiring feedback information from a viewer of the video, wherein the control unit controls playback of the video information based on the viewer's feedback information acquired by the feedback acquisition unit. This enables the video information display device to control video display based on feedback information from viewers, thereby providing a more appropriate viewing experience.

According to a specific feature, the control unit continues playback while controlling it based on the viewer's feedback information acquired by the feedback acquisition unit after video playback has started.

According to a more specific feature, the control unit determines the viewer's pleasantness or unpleasantness based on the viewer's feedback information acquired by the feedback acquisition unit and controls playback based on the determination of the viewer's pleasantness or unpleasantness.

According to another more specific feature, the control unit controls the playback of the video information to demote the determination of the viewer's pleasantness or unpleasantness when the feedback acquisition unit has performed the determination.

According to still another more specific feature, the control unit controls the playback of the video information to promote the determination of the viewer's pleasantness or unpleasantness when the feedback acquisition unit has performed the determination.

According to still another more specific feature, the control unit controls the playback of the video information in the manner to lead the viewer and to elicit a reaction when the feedback acquisition unit fails to detect reaction from the viewer.

According to still another more specific feature, the control unit controls the playback of the video information to lead the viewer toward positive emotions in response to any of viewer's pleasantness or unpleasantness.

According to another specific feature, the video information is provided with association information. According to a more specific feature, the association information is information about the original image from which the video generated. According to another more specific feature, the association information is information identifying individuals appearing in the video. According to another more specific feature, the association information is information regarding pleasant or unpleasant states associated with the video. According to another more specific feature, the associated information is information related to the viewer's reaction history to that video. According to another more specific feature, the video is a video generated by a prompt-based generative AI, and the associated information is information related to the prompt used for generation.

According to another specific feature, the control unit is the generative AI. According to a specific feature, the generative AI generates response information based on words uttered by the viewer of the video and modifies the response information based on feedback information of the viewer's pleasant or unpleasant facial expressions.

According to still another specific feature, the feedback acquisition unit is a microphone, and the feedback information is the content of words uttered by the viewer. According to a more specific feature, the feedback acquisition unit is a microphone, and the feedback information is the tone of the viewer's voice. According to another more specific feature, the feedback acquisition unit is a camera, and the feedback information is the viewer's facial expression.

According to another feature, the present invention provides a video information display device comprising, generative AI for controlling video playback, and a display for displaying the video playback based on the control of the generative AI, wherein the generative AI controls the video playback based on feedback information of a viewer's facial expressions indicating pleasure or displeasure of the viewer viewing the video playback on the display.

According to still another feature, the present invention provides a video information display device comprising, generative AI for controlling video playback, and a display for displaying the video playback based on the control of the generative AI, wherein the generative AI generates response information to words of a viewer viewing the video playback on the display and modifies the response information based on feedback information of the viewer's facial expressions indicating pleasure or displeasure of the viewer.

### BRIEF DESCRIPTION OF THE DRAWINGS

FIG. 1 represents a block diagram showing the overall video information display system according to Embodiment 1 of the present invention.

FIG. 2 represents a block diagram showing the overall video information display system according to Embodiment 2 of the present invention.

FIG. 3 represents a block diagram showing the overall video information display system according to Embodiment 3 of the present invention.

FIG. 4 represents a block diagram showing the overall video information display system according to Embodiment 4 of the present invention.

FIG. 5 represents an explanatory diagram of the video creation method for an image processing company in the video information display system of the present invention.

FIG. 6 represents an explanatory diagram of the method for creating a long video by concatenating multiple videos according to the present invention.

FIG. 7 represents an explanatory diagram of the method for mitigating monotony when using the same video multiple times according to the present invention.

FIG. 8 represents a basic flowchart explaining the details of the functions in Embodiment 4 of FIG. 4.

FIG. 9 represents an explanatory diagram of another method for creating a long video by concatenating multiple videos according to the present invention.

FIG. 10 represents an explanatory diagram illustrating yet another method for creating a long video using multiple videos according to the present invention.

FIG. 11 represents an explanatory flowchart showing details of step S4 in the basic flowchart of FIG. 8.

FIG. 12 represents an explanatory flowchart showing details of step S24 in the basic flowchart of FIG. 8.

FIG. 13 represents a block diagram showing the entire video information display system according to Embodiment 5 of the present invention.

### DETAILED DESCRIPTION OF THE PREFERRED EMBODIMENTS

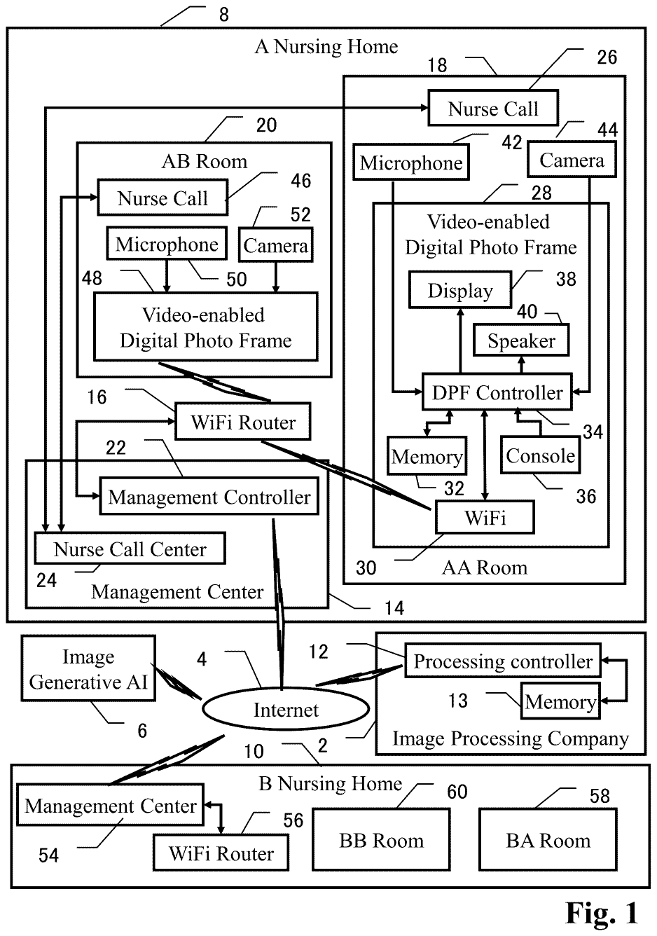

FIG. 1 is a block diagram showing the overall video information display system according to Embodiment 1 of the present invention. The system includes an image processing company 2, an image generative artificial intelligence (image generative AI) 6 used by this image processing company 2 via the Internet 4, and A nursing home 8 and B nursing home 10 each receiving services from the image processing company 2. Although the system includes numerous other nursing homes, for simplicity, The A nursing home 8 and B nursing home 10 are used as representative Embodiments for explanation. The image generative AI 6 provides a function to generate videos based on still images, and users of the image generative AI 6 can utilize this function via the Internet. The image processing company 2 can upload still images to the image generative AI 6 via the Internet 4 and generate desired videos by inputting specified prompts.

Image processing company 2 has a processing controller 12 that creates videos based on still image information provided by A nursing home 8 or nursing home B 10. Processing controller 12 collaborates with image generative AI 6 via the internet 4 to process the still image information and create videos. Processing controller 12 includes a CPU, and its memory unit 13 stores the program data necessary for its operation. The memory unit 13 also serves as a storage medium for program data required by the present invention's system. Details are described later.

The A nursing home 8 includes a management center 14, a WiFi router 16 under its control, and AA room 18 and AB room 20 for residents. The B nursing home 8 provides numerous other rooms for residents, but for simplicity, the explanation will be based on AA room 18 and AB room 20 as representative Embodiments. The management center 14 includes management controller 22 that controls the entire nursing home 8, and a nurse call center 24 that responds bidirectionally to nurse calls from AA room 18 and AB room 20.

AA room 18 is equipped with a nurse call system 26 featuring a call button, speaker, microphone, etc., enabling communication with the nurse call center 24 at the management center 14. AA room 18 also houses a video-enabled digital photo frame 28, which communicates with the WiFi router 16 via WiFi 30. This allows residents of AA Room 18 to communicate with management center 14 not only via the nurse call system 26 but also through the video-enabled digital photo frame 28. Hereinafter, residents of AA Room 18 and other rooms in the nursing home are defined as users of the video-enabled digital photo frame 28. Furthermore, as described below, staff members of A nursing home 8 and other nursing homes can also utilize the video-enabled digital photo frame 28 and are therefore users.

The operation of the video-enabled digital photo frame 28 is controlled by the video-enabled digital photo frame controller (hereinafter “DPF controller”) 34, which includes a CPU. The memory 32 stores the program data necessary for its operation and the video information to be displayed. Residents or staff of A nursing home 8 operate the video-enabled digital photo frame 28 by manually manipulating the console 36. Image output from the DPF controller 34 is displayed on the display screen 38, while audio output is delivered to the speaker 40.

An external microphone 42 and camera 44 are connected to the video-enabled digital photo frame 28. These devices are for capturing voice and facial expressions of the resident. The captured voice and facial expressions are input to video-enabled digital photo frame 28 as input operation information. Additionally, the captured voice and the facial expressions are used for identifying feelings of the resident viewing video content such as pleasure or displeasure. The identified feelings of the resident viewing video content is used as feedback information from viewing experience. This feedback information is reflected in the video creation by image processing company 2, the details of which will be described later.

AB room 20 in A nursing home 8 is also equipped with a nurse call system 46, a video-enabled digital photo frame 48, a microphone 50, and a camera 52. As these are identical to the corresponding components in AA room 18, their description is omitted. The internal details of the video-enabled digital photo frame 48 are also identical to those of the video-enabled digital photo frame 28 in AA room 18, so its illustration is omitted.

B nursing Home 10 also includes a management center 54, a WiFi router 56 under its control, and resident BA room 58 and BB room 60. However, these are identical to the corresponding parts in A nursing home 8, so their description is omitted. B nursing home 10 also provides numerous other rooms for residents. For simplicity, BA Room 58 and BB Room 60 are shown as representative Embodiments, similar to A nursing home 8. Details within the Management Center 54, BA Room 58, and BB Room 60 are also omitted from the illustration as they are identical to the corresponding parts in A nursing home 8.

Next, the details of the configuration of the present invention and its operation will be described. As described above, the video-capable digital photo frame 28 includes memory 32 for video information storage, DPF controller 34 that controls the playback of video information from the memory 32, and display screen 38 that plays back and displays video information based on the DPF controller 34. The memory 32 stores still image information input by the resident themselves. DPF controller 34 selects one of these images based on the resident's manual selection or automatic selection. It then sends an order to an external image processing company 2 to create video information based on this single still image. Specifically, this order is transmitted from management controller 22 of the management center 14 via the WiFi router 16 over the Internet 4 to the processing controller 12 of the image processing company 2.

The processing controller 12 of the image processing company 2 responds to this order by creating video information based on the received single still image and replying to the video-enabled digital photo frame 28. Specifically, the created video information is transmitted from the image processing company 2's processing controller 12 to the management controller 22 of the management center 14 via the Internet 4, and delivered to the WiFi 30 via the WiFi router 16. The DPF controller 34 of the video-enabled digital photo frame 28 receives the video information created by the external image processing company 2 in this manner and stores it in the memory 32. As described above, the DPF controller 34 and memory 32 function as a video information acquisition function unit to obtain videos based on a single still image. This enables residents of AA room 18 to view videos created from still images of themselves, family, friends, etc., from their younger days when no video existed, using the video-enabled digital photo frame 28 placed in AA room 18.

As described above, the DPF controller 34 of the video-compatible digital photo frame 28 includes a CPU, and the actual operation of the video information acquisition function unit described above is program data executed by this CPU. By receiving such program data from image processing company 2 and installing it, the functions proposed by the present invention can be added to an existing video information display device. In other words, by providing the program data of the present invention, Image Processing Company 2 can undertake the construction of a service system for creating video information from a single still image, from receiving orders to providing the processed product, as well as the execution of individual image creation services.

As described above, the video-capable digital photo frame 28 has a microphone 42 and a camera 44 connected to it, constituting feedback acquisition means for acquiring feedback information from the viewer, who is the resident. This feedback function can also be achieved using program data. Specifically, a function to transmit feedback information to Image Processing Company 2 is added to the program data. As described above, this feedback information is used by Image Processing Company 2 to modify the video information. Consequently, an external Image Processing Company 2 receiving orders to create video information can modify the video based on feedback from viewers and provide more appropriate videos to them.

Regarding the use of the feedback function, besides the feedback to the image processing company 2 mentioned above, it can also be utilized to control the display of video information on the display screen 38 within the video-compatible digital photo frame 28. This function can also be achieved by the program data in the memory unit 32 executed by the CPU of the DPF controller 34. Specifically, the DPF controller 34 of the video-capable digital photo frame 28 can control video display based on viewer feedback information obtained from the microphone 42 or camera 44, or both, thereby providing images more appropriately to viewers. More specifically, multiple different videos created based on the same still image are stored in the memory unit 32. The program data determines the viewer's satisfaction or dissatisfaction based on the feedback information and selects one of the multiple different videos. Alternatively, the program data determines the viewer's satisfaction or dissatisfaction based on the feedback information and changes the playback order of the multiple different videos. Through these actions, the video-capable digital photo frame 28 can change the selection or combination of multiple different videos created based on the same still image based on feedback information from the viewer, enabling it to provide a more appropriate soothing experience to the viewer.

Specifically, at the image processing company 2 that receives orders accompanied by still image information, the processing controller 12 creates video information. This video information is created by first generating multiple different short videos from the same still image, then connecting these multiple different videos together at the same still image portion to create a longer video than the sum of the individual videos. Furthermore, even during this video splicing process, the processing controller 12 can modify the provided longer video to better suit the viewer's relaxation needs. This is achieved by receiving feedback from residents viewing the longer video on the video-enabled digital photo frame 28. Specifically, feedback is gathered from a microphone capturing the viewer's voice or a camera recording the viewer's facial expressions.

As described above, in the video-capable digital photo frame 28, WiFi 30 serves as the communication unit with the external image processing company 2. It communicates with the processing controller 12 of the image processing company 2 via the Internet 4, through the WiFi router 16 and the management controller 22 of the management center 14. Furthermore, in the video-capable digital photo frame 28, the memory 32 serves as the storage unit for video information, and the DPF controller 34 functions as the controller that controls the playback of video information, thereby controlling the display screen 38 that plays and displays the video information. The DPF controller 34 includes a CPU, controls the functions of the entire device, and the memory 32 also serves as the program data storage unit that stores program data for this CPU. As described above, the video-capable digital photo frame 28 possesses a video information acquisition function. This function sends orders from WiFi 30 to the image processing company 2 to create video information based on a single still image stored in memory 32. It also receives the video information created by the image processing company 2 via WiFi 30 and stores it in memory 32.

The program data that enables the DPF controller 34 of the video-capable digital photo frame 28 to execute these functions is stored in memory unit 13 of the image processing company 2. By providing this program data to the video-capable digital photo frame 28, it can be stored in the memory unit 32. In other words, the memory unit 13 of the image processing company 2 serves as a storage medium that provides the program data for the video information acquisition function unit in the system of the present invention. This program data is then provided to the video-capable digital photo frame 28.

By utilizing such a storage medium, the video information acquisition function proposed by the present invention can be installed on existing video information display devices. Specifically, as described above, the program data for the video information acquisition function is stored on storage medium 13 within image processing company 2. This is sold by image processing company 2 via the Internet and downloaded/installed into the memory 32 of the video-compatible digital photo frame 28 via WiFi 30. The program data for the video information acquisition function stored on storage medium 13 can also be provided to the video-compatible digital photo frame 28 by storing it on a USB memory or DVD sold by image processing company 2. In this case, the USB memory or DVD sold by image processing company 2 becomes the storage medium for the system of the present invention. Furthermore, since the program data for the video information acquisition function is stored in the memory unit 32 of the video-capable digital photo frame 28 upon installation, the memory unit 32 becomes the program data storage unit of the system of the present invention.

By utilizing such storage media, the video information acquisition function proposed by the present invention can be installed on existing video information display devices. Specifically, as described above, the program data for the video information acquisition function is stored on storage medium 13 within image processing company 2. This is sold by image processing company 2 via the Internet and downloaded/installed into the memory section 32 of the video-compatible digital photo frame 28 via WiFi 30. The program data for the video information acquisition function stored on storage medium 13 can also be provided to the video-compatible digital photo frame 28 by storing it on a USB memory or DVD sold by image processing company 2. In this case, the USB memory or DVD sold by image processing company 2 becomes the storage medium for the system of the present invention. Furthermore, since the program data for the video information acquisition function is stored in the memory unit 32 of the video-capable digital photo frame 28 upon installation, the memory unit 32 becomes the program data storage unit of the system of the present invention.

Furthermore, as described above, the video-capable digital photo frame 28 includes feedback acquisition means for acquiring feedback information from viewers of the video information. More specifically, the program data provided by image processing company 2 includes a function to transmit information to image processing company 2 via WiFi 30, enabling image processing company 2 to modify the video information based on this feedback information. As described above, the feedback means is a microphone 42 that picks up the viewer's voice or a camera 44 that detects the viewer's facial expressions. Note that the video information subject to modification may be created by connecting multiple different videos generated based on the same still image at the same still image portion, thereby forming a video longer than the sum of the individual videos.

In the system of the present invention, by linking the functions of the video-enabled digital photo frame 28 with the two-way communication function via the nurse call system 26, it is possible to provide enhanced care to the AA patient room 18. Specifically, by automatically starting video playback on the video-enabled digital photo frame 28 in response to the nurse call button 26 being pressed, it alleviates the time residents spend idly waiting for the nurse call to be answered or for the staff member who received the call to actually arrive at AA Room 18. That is, residents can watch videos while waiting for the nurse call to be addressed, which can provide some distraction and is expected to alleviate feelings of irritation. Furthermore, the displayed videos can be created using still images of the resident in their younger years, along with family and friends. This makes them potentially more emotionally resonant for the resident than unrelated television programs.

Additionally, according to the present invention's system, the video playback via the video-enabled digital photo frame 28 is controlled from the nurse call center 24 side. Specifically, when a nurse call is received but staff cannot immediately respond due to attending to other residents, the system can not only verbally convey a request to wait via the nurse call system but also alleviate the resident's frustration by playing a video on the video-enabled digital photo frame 28. In such cases, the nurse call center 24 can switch the video being played on the frame to a pre-selected appropriate video. Such videos could include not only images of the resident in the room of A Nursing Home 8 but also videos of staff members at A Nursing Home 8 responding to the nurse call, stored in the video-enabled digital photo frame 28, allowing selection for playback. Furthermore, the nurse call center 24 may control playback on the video-enabled digital photo frame 28 based on feedback received via WiFi 16, such as the resident's voice or facial expressions.

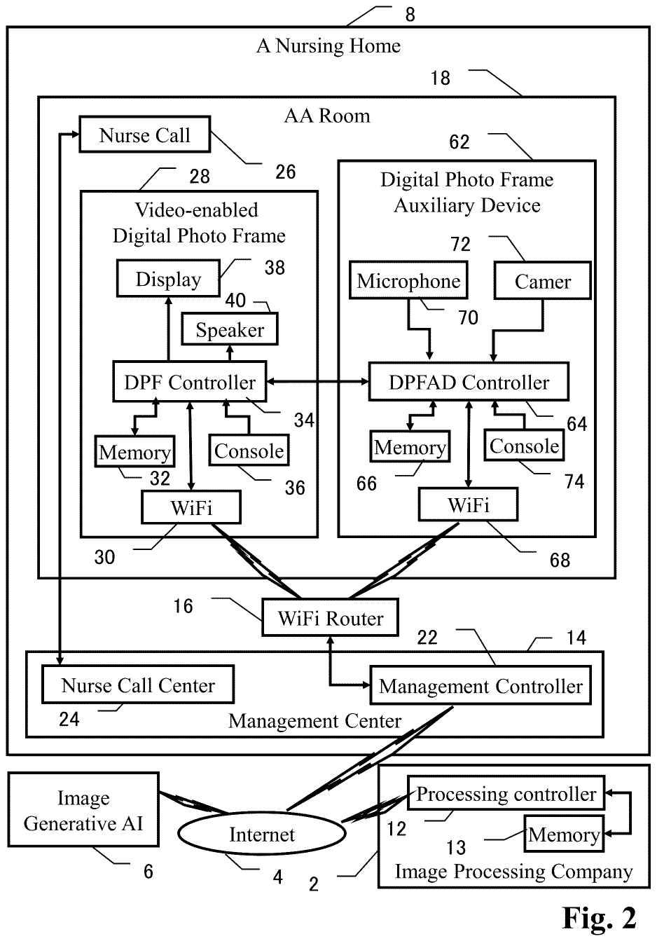

FIG. 2 is a block diagram showing the overall video information display system according to Embodiment 2 of the present invention. In Embodiment 2, functions for creating video information based on a single still image upon request, receiving externally created video information and storing it in the memory, and acquiring and utilizing feedback information from viewers of the video information are entrusted to a separate digital photo frame auxiliary device 62. Such a digital photo frame auxiliary device 62 is provided to AA Room 18 through collaboration with or mediation by Image Processing Company 2. The digital photo frame auxiliary device 62 then interfaces with the video-enabled digital photo frame 28 to achieve functionality similar to Embodiment 1. In this case, the video-capable digital photo frame 28 may be a conventional video information display device comprising a video information memory 32, a DPF controller 34 that controls playback of the video information in memory 32, and a display screen 38 that plays and displays the video information based on that control.

Other configurations related to normal operation within the video-capable digital photo frame 28 in FIG. 2, and other configurations within the system, are common to FIG. 1 and are omitted unless necessary. Furthermore, for simplicity, the configuration of AB Room 20 and B Nursing Home in FIG. 1 is omitted from FIG. 2 and its description.

In FIG. 2, the digital photo frame auxiliary device 62 includes an assist device controller (hereinafter referred to as the “DFPAD controller”) 64, which stores still images transferred from the memory unit 32 of the video-compatible digital photo frame 28 via wired or wireless means into the memory unit 66. The DFPAD controller 64 performs the functions of an order unit, which sends orders via WiFi 68 to image processing company 2 to create video information based on a single still image stored in the memory 66, and a video information provision unit, which receives the video information created by image processing company 2 via WiFi 68 and stores it in the memory 66. The video stored in memory 66 is transferred to memory 32 and can be displayed on display screen 38. In handling such orders and video information provision, DFPAD controller 64 can also function to directly transmit the single still image stored in memory 32 to image processing company 2 in coordination with video-compatible digital photo frame 28, and to directly receive and store the created video information in memory 32. As described above, the digital photo frame auxiliary device 62 collaborates with a standard video-compatible digital photo frame 28 connected via wired or wireless means to realize the display of video information created from a single still image.

The digital photo frame auxiliary device 62 includes feedback acquisition means for obtaining feedback information from viewers of the video information. Specifically, the feedback acquisition means comprises a microphone 70 and a camera 72 built into the digital photo frame auxiliary device 62. Similar to Embodiment 1, the feedback information is used by the image processing company 2 to modify the video information. The digital photo frame auxiliary device 62 transmits the acquired feedback information to the image processing company 2 via WiFi 68. Furthermore, the digital photo frame auxiliary device 62 includes an operation unit 74 for inputting necessary manual operation information.

Similar to Embodiment 1, the feedback information is also used to control the display on the display screen 38 of the video-compatible digital photo frame 28. Specifically, the DFPAD controller 64 of the digital photo frame auxiliary device 62 functions as a controller that collaborates with the DPF controller 34 of the video-compatible digital photo frame 28 to control the display of video information on the display screen 38 based on the feedback information. Furthermore, as in Embodiment 1, when the video information includes multiple different videos created based on the same still image, the DFPAD controller 64 collaborates with the DPF controller 34 to select among the multiple different videos based on the feedback information. Additionally, the DFPAD controller 64 collaborates with the DPF controller 34 to change the playback order of the multiple different videos based on the feedback information.

Furthermore, the features of the present invention described above contribute to providing a video-enabled digital photo frame that soothes residents through interactive display control, not only when combined with video creation in collaboration with an external image processing company 2, but also when functioning solely within the AA residence. Specifically, the collaboration between the video-enabled digital photo frame 28 and the digital photo frame auxiliary device 62 comprises: a video information memory 32; a DPF controller 34 that controls playback of video information from memory 32; a display screen 38 that displays video information based on DPF controller 34; and feedback acquisition means comprising a microphone 70 and camera 72 that acquire feedback information from video viewers. The DFPAD controller 64 collaborates with the DPF controller 34 to control the playback of video information based on viewer feedback information acquired by the feedback acquisition means. This collaboration between the video-capable digital photo frame 28 and the digital photo frame auxiliary device 62 enables the control of video display based on feedback from viewers, thereby providing viewers with more appropriate videos. Specifically, the DPF controller 34 continues playback while controlling it based on viewer feedback information acquired by the feedback acquisition means after video playback begins. The DFPAD controller 64 then determines viewer satisfaction or dissatisfaction based on the viewer feedback information acquired by the feedback acquisition means. Based on this determination, it coordinates with the DPF controller 34 to control playback.

For example, when the video information in the memory 32 includes identical images that repeatedly appear midway through, the DFPAD controller 64 instructs the DPF controller 34 to seamlessly reorder the video playback sequence by skipping from the identical image section to an identical portion located elsewhere, based on the feedback information. Furthermore, when the video information in the memory 32 is created based on a single still image, the DFPAD controller 64 instructs the DPF controller 34 to seamlessly replace the video playback sequence by skipping from such a still image portion to another still image portion located elsewhere, based on the feedback information. Alternatively, the DFPAD controller 64 instructs the DPF controller 34 to change the playback speed of the video information based on viewer feedback information acquired by the feedback acquisition means.

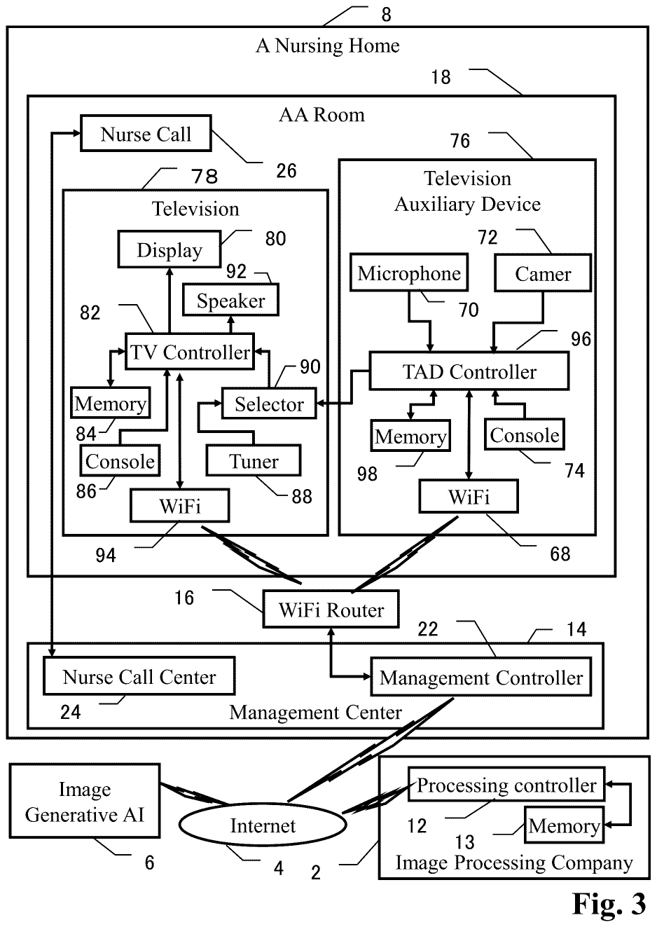

The above described the bidirectional display control for soothing residents within the AA room using Embodiment 2 in FIG. 2. Such usefulness is similarly applicable to Embodiment 1 in FIG. 1. In the case of Embodiment 1 in FIG. 1, all functions of the interactive display control based on feedback information described in FIG. 2 are handled by the DPF controller 34. If the video-capable digital photo frame 28 is a standard model, the necessary functions can be added by installing program data stored on a storage medium into the memory 32.
FIG. 3 is a block diagram showing the overall video information display system according to Embodiment 3 of the present invention. Embodiment 3 achieves functions similar to those of Embodiments 1 and 2 by combining a video information display auxiliary device 76, having a configuration substantially similar to that in Embodiment 2 of FIG. 2, with a conventional television 78. That is, it causes the video information display auxiliary device 76 to display videos according to the present invention using the display screen 80 of the television 78.

As described above, the television 78 is a conventional television whose operation is controlled by the television controller (hereinafter referred to as the “TV controller”) 80. The memory unit 84 stores the program data necessary for its operation. Residents or staff of Nursing Home A 8 operate the television 78 by manually operating the console 86. TV program signals are input from the tuner 88 to the TV controller 82 via the input selector 90. The video output is displayed on the display screen 80, and the audio output is output to the speaker 92. Furthermore, the TV controller 82 is also connected to the WiFi 94, enabling internet connectivity.

In the television auxiliary device 76 of Embodiment 3 shown in FIG. 3, the TAD controller 96 combines the functions of the DFPAD controller 64 and the DPF controller 34 in Embodiment 2 of FIG. 2. Correspondingly, the memory unit 98 of television auxiliary device 76 in the Embodiment 3 also combines the functions of the memory unit 66 and the memory unit 32 in Embodiment 2, respectively. That is, the functions of ordering and storing video information, as well as controlling the video information to be displayed, are all entrusted to the TAD controller 96 and the memory 98. Video information that can be directly supplied to the television 78 for display on the display screen 80 is provided via the input selector 90. Thus, by providing the video information display auxiliary device 76 equipped with all the functions described in Embodiment 2, it becomes possible to provide and display video according to the present invention using the display screen 80 of a conventional television 78.

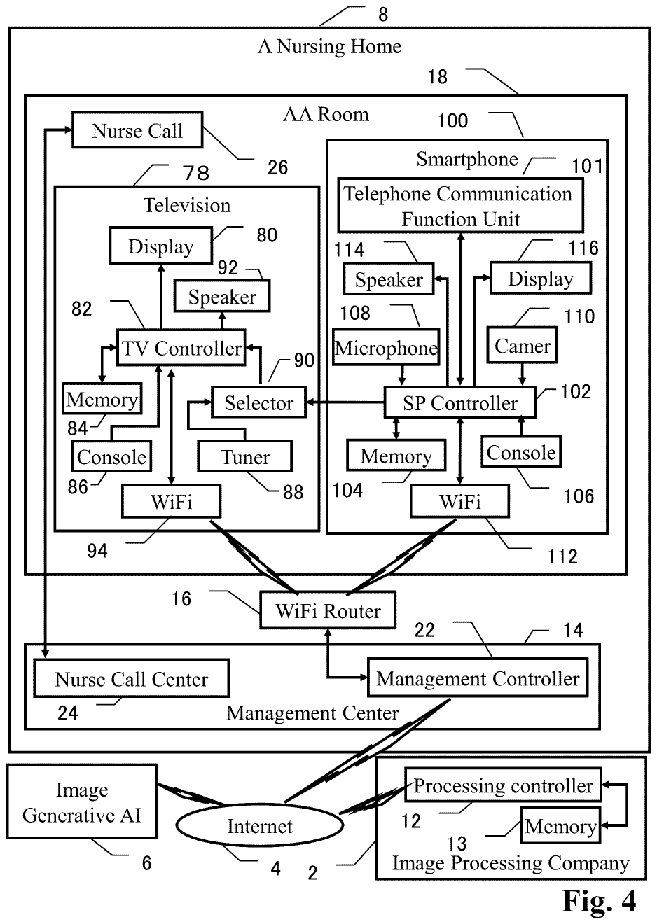

FIG. 4 is a block diagram showing the overall video information display system according to Embodiment 4 of the present invention, which achieves the functions of the video information display auxiliary device 76 in Embodiment 3 by repurposing a smartphone 100. The smartphone 100 includes a telephone communication function unit 101, a smartphone controller (hereinafter referred to as “SP controller” 102) containing a CPU, and a memory unit 104 for storing program data necessary for smartphone operation. The SP controller 102 and memory unit 104 perform the normal smartphone functions while also being repurposed to perform the functions of the television auxiliary device 76 described in Embodiment 3. The necessary program data for this purpose is obtained from the image processing company 2, as in Embodiment 1. Once installed, it functions identically to the video information display assist device of Embodiment 3 shown in FIG. 3. The console 106, microphone 108, camera 110, and Wi-Fi 112 are also fundamentally provided for smartphone functions but are repurposed for functions similar to those of the video information display assist device of Embodiment 3 shown in FIG. 3.

The smartphone 100 includes a speaker 114 and a display screen 116 for its functions, but these can also be repurposed for the functions of the present invention. That is, when the speaker 114 and display screen 116 are also repurposed for the functions of the present invention, their configuration becomes equivalent to that of the video-compatible digital photo frame 28 in Embodiment 1 of FIG. 1, with a microphone 42 and camera 44 connected. In other words, by displaying videos on display screen 116 instead of television 78 in FIG. 4, the smartphone 100 alone can achieve the functions of the present invention equivalent to those of Embodiment 1 in FIG. 1. In this case, if a smaller display screen is acceptable, television 78 becomes unnecessary in FIG. 4. However, attempting to achieve all functions solely with smartphone 100 requires that the resident be proficient in smartphone operation and in a physical condition where they do not find it inconvenient. Each embodiment proposed by the present invention is based on various considerations to allow residents to enjoy videos without requiring complex operations.

Details of the functions of Embodiment 4 in FIG. 4 are equivalent to those described in Embodiments 1 to 3 of FIG. 1, so further explanation is omitted.

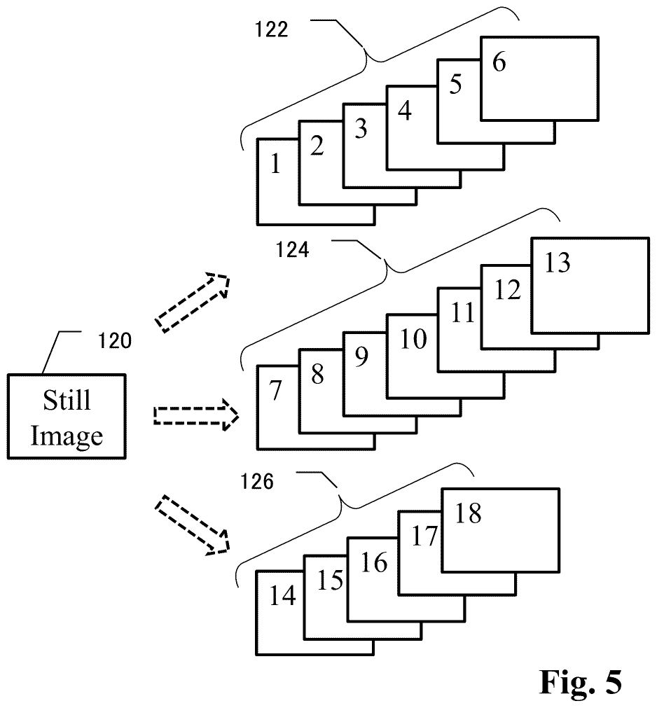

FIG. 5 is an explanatory diagram of the video creation method used by image processing company 2, common to Embodiments 1 through 4. According to the video creation method of the present invention, as shown in FIG. 5, multiple different videos 122, 124, 126, etc., are created based on the same still image 120. Specifically, video 122 comprises six frames from the first frame to the sixth frame, video 124 comprises seven frames from the seventh frame to the thirteenth frame, and video 126 comprises five frames from the fourteenth frame to the eighteenth frame. To achieve a smooth video, more frames are actually created, but the number of frames is reduced for illustrative purposes. The created videos, for example in video 122, progressively change the image slightly: the first frame most closely approximates the original still image 120, the second frame approximates the first frame, the third frame approximates the fourth frame, and so on. This change is based on the prompt given to the image generative AI 6. For example, giving the prompt “smile” causes the images to change sequentially from the neutral face still image 120, with each frame gradually becoming more smiling towards the sixth frame. Playing this as a video results in a video where a person who was neutral-faced appears to smile. Similarly, in video 124, the seventh frame most closely approximates the original still image 120, and in video 126, the fourteenth frame most closely approximates the original still image 120.

Videos 122, 124, 126, etc., can be made different by changing the prompt to “smile,” “sneer,” “forced smile,” “burst of laughter,” etc. Even with the same prompt, different results can be obtained through multiple trials. Furthermore, while videos 122, 124, 126 are examples differing in the number of frames (video length), these can also be selected appropriately. However, since the original information is a single still image, excessive length risks unnatural deviation from the original image. Conversely, avoiding such deviation may lead to monotonous repetition. Length also impacts video production costs, necessitating consideration of cost-effectiveness to create videos satisfying to viewers.

Therefore, in the present invention, multiple different short videos 122, 124, 126, etc. are first created based on the same still image 120. Then, these multiple different short videos 122, 124, 126, etc. are shown to a viewer (e.g., the person depicted in the still image or a close relative), and feedback information is obtained. Based on this feedback information, a selection is made of which video to adopt from the multiple different videos. This enables the creation of an appropriate video based on feedback from the viewer. As mentioned earlier, feedback from the viewer can include, for example, the viewer's voice or facial expressions. If satisfaction is achieved with multiple videos through such feedback, these can be combined into a longer video. In this case, connecting them at the same original still image section enables seamless splicing. The aforementioned feedback from the viewer can then be utilized to select the videos to be adopted for such splicing.

According to the present invention, as shown in FIG. 5, multiple different videos can be generated based on the same still image. A provisional video can be adopted and shown to the viewer, who then provides feedback information to judge its suitability. If viewer satisfaction is achieved, the provisionally adopted video is adopted permanently. If the viewer is dissatisfied, the video is replaced with another one. Appropriate video creation remains possible even through such replacements. In this case too, viewer feedback information, such as the viewer's voice or facial expressions, can be utilized. Furthermore, when seamlessly creating a longer video by splicing together multiple different videos at the same still image section, replacing parts based on feedback information allows for improvement into a longer video that better meets viewer preferences.

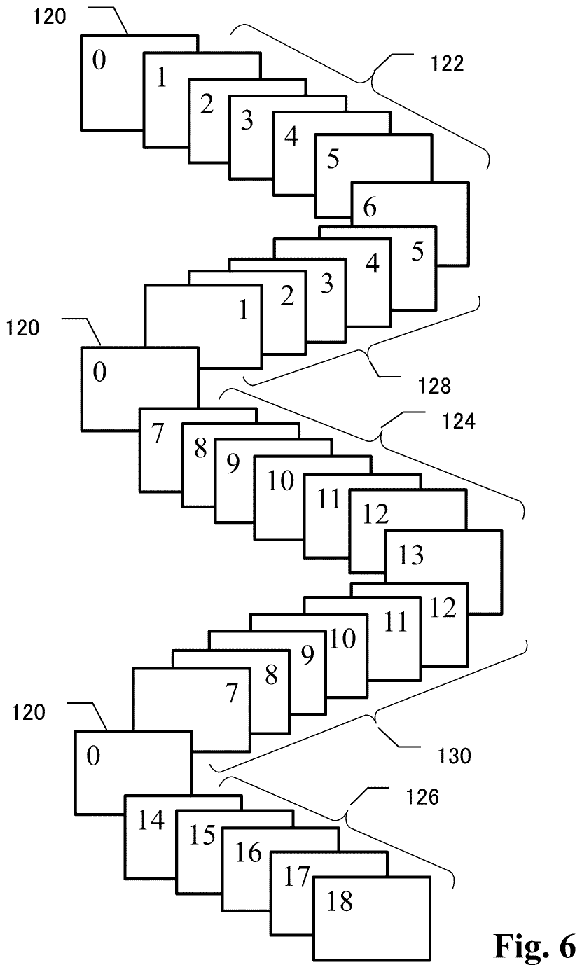

FIG. 6 is an explanatory diagram illustrating an example method for seamlessly creating a longer video by connecting multiple different videos using the same static image section. This method is common to Embodiments 1 through 4. In the method of FIG. 6, multiple different videos 122, 124, 126, etc., are first created based on the same still image 120. Then, a video 128, which is a reverse playback of video 122, is created. Similarly, a video 130, which is a reverse playback of video 124, is created. Similarly, although not shown, it is possible to create a reverse playback video from video 126.

This allows, for example, video 122 to transition from frame 1 to frame 6 (e.g., a smiling face) based on the still image (e.g., a neutral face) shown as frame 0, and then reverse play from frame 6 (e.g., a smiling face) back to frame 1, returning to the still image 120 (e.g., a neutral face). This enables the seamless creation of a video twice as long, such as one transitioning from a neutral face to a smile and then back to a neutral face, from a video showing the transition from a neutral face to a smile.

Similarly, for video 124, the image transitions from frame 7 to frame 13 (e.g., a different smiling face) based on a still image (e.g., a neutral face). From frame 13 (e.g., a different smiling face), it reverses back to frame 7, seamlessly creating a video twice as long that returns to still image 120 (e.g., a neutral face).

Then, by connecting the video 122 that has returned to the still image 120 as described above to the video 124 starting from the still image, as shown in FIG. 6, a long video can be seamlessly created that starts from the still image 120 (e.g., a neutral expression), transitions through videos 122 and 128 (e.g., a first smile), returns to the still image 120 (e.g., neutral expression), then transitions through video 124 and 130 (e.g., a second smile) before returning to still image 120 (e.g., neutral expression). From the viewer's perspective, this creates a long video where the subject smiles twice with different expressions without interruption, reducing the sensation of monotonous repetition. Furthermore, by connecting video 126 to the still image 120 (e.g., neutral expression) returned from video 130 and performing the same process, it is possible to create an even longer and more diversely changing video. If there are many types of videos, similarly, it is possible to create a long, non-boring video based on a single still image.

Moreover, In the method shown in FIG. 6, for example, creating a sequence that gradually trims images back to still image 120 based on video 128 and adopting this reduces the likelihood of noticing that video 128 is a reverse playback of video 122. Furthermore, since the still image 120 returned after the reverse playback of video 128 is a trimmed version of the starting frame of video 122, the likelihood of noticing it is the same still image is also reduced. Similarly, by creating and adopting a sequence where images gradually revert from a cropped state based on video 124, with the cropping state resolved at the 13th frame, while using the original video 130, the likelihood of noticing that video 130 is a reverse playback of video 124 is reduced. Furthermore, and since the still image 120 returned after the reverse playback of video 130 becomes identical to the one at the start of video 122, the appearance of the exact same still image is reduced from three times to two times, further reducing the likelihood of it being recognized as identical. The above explanation simplified the trimming method, but by combining trimming in this way, the trimming state of the restored still image can be freely selected, and it is also possible to eliminate the restoration to an exact identical still image.

It is possible to create a long video by progressively transforming and developing a single still image, regardless of the creation method of the present invention. However, since the original information is a single still image, excessive transformation risks creating discomfort or unnaturalness due to deviation from the original still image. In contrast, the method of the present invention avoids unnatural deviations by returning to the original still image. Furthermore, by connecting different videos, it avoids monotony caused by repetition. In other words, by keeping individual videos short, it prevents the development of videos that deviate excessively from the original still image and become jarring, while still enabling the creation of long videos. Moreover, keeping individual videos short also lowers the creation cost from the still image.

Furthermore, even if the number of source videos is limited to, say, five types, the present method allows creating longer videos by using each multiple times. To avoid monotony from repeated appearances of the same video, the order of appearance between different videos can be randomized, or the frequency of each video's appearance can be varied to mitigate monotony arising from predictability.

To further alleviate monotony when using the same video multiple times, when reversing playback of one of the videos, it is reversed from a different section. Additionally, for the same purpose, the playback speed is varied from its previous appearance. Needless to say, combining these techniques with the trimming described above can further reduce monotony.

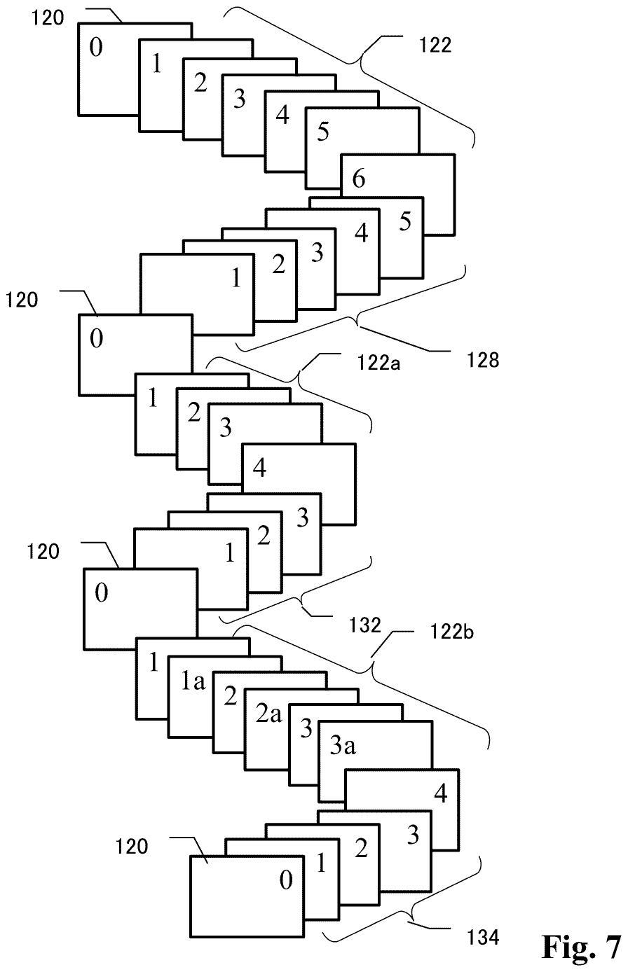

FIG. 7 illustrates a method for mitigating monotony when using the same video multiple times, common to Embodiments 1 through 4. As shown in FIG. 7, this method creates video 122a by adopting frames 1 through 4 from video 122 (originally consisting of six frames). Video 132 is then created by reversing video 122a, resulting in still image 120. This allows the same video material to be used, but during viewing, facial expressions revert to their original state partway through, providing a perception different from repeating the same video.

Furthermore, FIG. 7 shows the creation of video 122b, which plays the first four frames of video 122 at half speed. To prevent the images from appearing jerky, frames 1a, 2a, and 3a are created for interpolation, resulting in a smooth video. Additionally, a video 134 is created that plays at the original speed during reverse playback (video 132 may be reused), ensuring variation in both forward and reverse directions. This variation may be achieved by having the forward direction play at normal speed and the reverse direction play at half speed. Alternatively, both forward and reverse playback could be set to half speed.

To achieve double playback speed, frames are thinned. For example, in videos 122 and 128, odd-numbered frames are removed. Video 122 retains frames 2, 4, and 6, while video 128 retains frames 6, 4, and 2. This makes the speed from frame 2 to frame 6 in the thinned video 122 equal to the speed from frame 1 to frame 3 in video 122a, doubling the playback speed of video 122 relative to video 122a. Note that the above explanation simplified the thinning method, focusing on the simple cases of halving and doubling the speed. However, the interpolation method, thinning method, and their locations can be freely selected, enabling diverse variations to mitigate monotony.

As described above, the method of FIG. 7 prevents falling into monotonous repetition even when using the same video, not merely repeating it, but by changing the position of reverse playback or altering the playback speed. Furthermore, by combining this method with the splicing with other videos described in FIG. 6, along with changes in the appearance order and frequency of individual videos during splicing, and further incorporating trimming and mixing, it is possible to generate even more diverse variations.

The various features of the present invention described above can be applied in diverse ways, irrespective of the specific embodiments. For example, the integration between the nurse call system and the video information display device can offer benefits not only when displaying videos but also when displaying still images. In this case, the integration with the nurse call system proposed by the present invention is possible not only with digital photo frames capable of handling videos, such as the video-compatible digital photo frame 28, but also with digital photo frames designed solely for still images.

To summarize the features of the present invention in the above embodiments, The present invention provides a video information display device comprising: a video information storage unit; a control unit for controlling playback of the video information in the storage unit; a display screen for displaying the video information based on the control unit; and a video information acquisition function unit for transmitting an order to an external source to create video information based on a single still image stored in the storage unit, and for receiving the video information created by the external source and storing it in the storage unit. This enables, for example, residents of nursing homes to view videos created from still images of themselves, family members, friends, etc., from their youth when no video footage exists, using a video information display device placed in their room. The video information display device may utilize a television or be configured as an electronic photo frame or digital photo frame.

According to a specific feature of the present invention, the video information display device has a CPU, and the video information acquisition function unit is program data executed by the CPU. According to a further specific feature, the program data is provided from the external source for installation. This enables the functions proposed by the present invention to be added to existing video information display devices.

According to a further specific feature of the present invention, the video information display device has feedback acquisition means for acquiring feedback information from viewers of the video information. According to a more specific feature, the program data includes a function for transmitting the feedback information to the external source. According to a further specific feature, the feedback information is for the external source to modify the video information based thereon. This enables external service providers receiving orders to create video information to modify the video based on feedback information from viewers and provide more appropriate video to viewers. Feedback information from viewers may include, for example, the viewer's voice or the viewer's facial expressions.

According to another specific feature of the present invention, the control unit is program data executed by the CPU, controlling the display of the video information on the display screen based on the feedback information. This enables the video information display device to control video display based on feedback information from viewers, providing a more appropriate experience to viewers. According to a more specific feature, the video information includes multiple different videos created based on the same still image. According to a further specific feature, the program data includes a step of selecting the plurality of different videos based on the feedback information. Furthermore, the program data changes the playback order of the plurality of different videos based on the feedback information. Through these actions, the video information display device can change the selection or combination of the plurality of different videos created based on the same still image based on feedback information from the viewer, thereby providing a more appropriate experience to the viewer.

According to another specific feature of the present invention, the video information is created by connecting the multiple different videos using the same still image portion, forming a video longer than the multiple individual videos. This enables the creation of a longer video by seamlessly connecting short, different videos created from the same still image information. The feedback means specifically refers to a microphone that picks up the viewer's voice or a camera that detects the viewer's facial expressions.

According to another feature of the present invention, the video information display device is coupled with a communication unit for external communication, a storage unit for video information, a control unit for controlling the playback of the video information, a display screen for displaying the video information based on the control unit, a CPU for controlling the overall function of the device, and a program data storage unit for storing program data for the CPU. characterized by providing a storage medium that stores program data for the program data storage unit. This program data includes video information acquisition functions. These functions send orders to the external entity via the communication unit to create video information based on a single still image stored in the storage unit. They also receive the video information created by the external entity via the communication unit and store it in the storage unit. By utilizing such a storage medium, the functions proposed by the present invention can be installed on existing video information display devices. According to a specific feature, the video information display device includes feedback acquisition means for acquiring feedback information from viewers of the video information. According to a more specific feature, the program data includes a function for causing the external entity to transmit information to the external entity via the communication unit for modifying the video information based on the feedback information. According to a further specific feature, the feedback acquisition means is specifically a microphone that picks up the viewer's voice or a camera that detects the viewer's facial expressions. According to another specific feature, the video information is created by connecting together multiple different videos generated based on the same still image at the same still image portion, forming a video longer than the multiple individual videos.

According to another feature of the present invention, a video information display device is provided, which has a video information storage unit, a control unit that controls the playback of the video information in the storage unit, and a display screen that displays the video information based on the control unit. The device is in cooperation with an order unit that transmits an order to an external entity to create video information based on a single still image stored in the storage unit, and a video information provision unit that receives the video information created by the external entity and stores it in the storage unit. and a video information provision unit that receives the video information created by the external entity and stores it in the storage unit. A video information display auxiliary device is provided, characterized by having these components. It can provide the functions proposed by the present invention through wired or wireless connection with an existing video information display device. According to a specific feature, the video information display auxiliary device has feedback acquisition means for acquiring feedback information from viewers of the video information. According to a further specific feature, the feedback information is for the external entity to modify the video information based thereon. According to a more specific feature, the video information display auxiliary device has a control unit for controlling the display of the video information on the display screen based on the feedback information. According to another specific feature, the video information includes multiple different videos created based on the same still image. According to a further specific feature, the video information display assist device selects the multiple different videos based on the feedback information. According to yet another specific feature, the video information display assist device changes the playback order of the multiple different videos based on the feedback information. The video information display assist device, as the feedback means, specifically includes a microphone that picks up the viewer's voice or a camera that detects the viewer's facial expressions.

According to another feature of the present invention, a video information display device is provided, characterized by comprising: a storage unit for video information; a control unit for controlling playback of the video information in the storage unit; a display screen for displaying the video information based on the control unit; and feedback acquisition means for acquiring feedback information from a viewer of the video. The control unit controls playback of the video information based on the viewer's feedback information acquired by the feedback acquisition means. This enables the video information display device to control video display based on feedback information from viewers, thereby providing a more appropriate viewing experience. According to a specific feature, the control unit continues playback while controlling it based on the viewer's feedback information acquired by the feedback acquisition means after video playback has started. According to a further specific feature, the control unit determines the viewer's level of satisfaction or dissatisfaction based on the viewer's feedback information acquired by the feedback acquisition means and controls playback based on this determination. According to a more specific feature, the video information in the storage unit includes identical images that repeatedly appear during playback. The control unit seamlessly rearranges the video playback sequence by skipping from the identical image portion to another identical portion located elsewhere, based on the feedback information. According to a further specific feature, the video information in the storage unit is created based on a single still image, and the control unit seamlessly replaces the video playback sequence by skipping from a portion of the still image to another portion of the still image located elsewhere, based on the feedback information. According to another specific feature, the control unit controls the playback speed of the video information based on the viewer's feedback information acquired by the feedback acquisition means. The video information display device includes, as the feedback means, specifically, a microphone that picks up the viewer's voice or a camera that detects the viewer's facial expressions.

According to another feature of the present invention, a video creation method is provided, characterized by comprising: a step of generating multiple different videos based on the same still image; a step of acquiring feedback information from a viewer of the video information; and a step of selecting one of the multiple different videos based on the feedback information. This enables the creation of an appropriate video based on feedback information from the viewer. The feedback information from the viewer may utilize, for example, the viewer's voice or the viewer's facial expressions. As a specific feature, the video creation method may include the step of connecting the selected plurality of different videos using the same still image portion to create a video longer than the plurality of individual videos, and the step of storing the longer video.

According to another feature of the present invention, a video creation method is provided, characterized by comprising: a step of generating a plurality of different videos based on the same still image; a step of acquiring feedback information from viewers of the video information; and a step of replacing the plurality of different videos based on the feedback information. This enables the creation of an appropriate video based on feedback information from viewers. The feedback information from viewers may include, for example, the viewer's voice or facial expressions. As a specific feature, the video creation method may include the step of connecting the selected plurality of different videos using the same still image portion to create a longer video than the plurality of individual videos, and the step of storing the longer video.

According to another feature of the present invention, a video creation method is provided, characterized by comprising the steps of: generating a plurality of different videos based on the same still image; connecting the plurality of different videos using the same still image portion to create a longer video than the plurality of individual videos; and storing the longer video. This enables the creation of a longer video by seamlessly connecting different short videos created from the same still image information. In this way, while keeping the individual videos themselves short, it is possible to create a long video while preventing it from deviating too far from the original still image and developing into an awkward-looking video. Furthermore, if the individual videos are short, creation from the still image becomes easier.

According to a specific feature, the video creation method of the present invention returns to the same still image by reversing playback of one of the multiple videos from a point in the middle and connects this to another one of the multiple videos. This enables the multiple different videos to be seamlessly connected at the same still image portion.

According to a more specific feature, the video creation method of the present invention reverses playback of one of the multiple videos starting from a different portion. This enables the creation of multiple different videos from a single same video source.

According to another specific feature, the video creation method of the present invention uses one of the multiple different videos multiple times when creating the long video. This enables the creation of a longer video. According to a further specific feature, when using one of the multiple different videos multiple times, the order of appearance of the multiple different videos is randomized. This makes it less noticeable that the same video is used multiple times. According to another specific feature, when using one of the multiple different videos multiple times, the playback speed is varied from the previous instance to make the repeated use less noticeable.

The above specific features are useful for creating long videos that do not cause viewer fatigue from repetition of the same material, despite being composed of short videos based on the same still image information.

According to another feature of the present invention, a video information display system is provided, characterized by comprising a video information display device placed in a resident's room for displaying images, and a nurse call system enabling two-way communication between the room and a management center, wherein the video information display device and the nurse call system are linked. According to a specific feature, image playback automatically starts in response to the resident pressing the call button on the nurse call system. This alleviates the resident's idle waiting time for a response to the nurse call or the time until nursing home staff actually arrive at the room after receiving the call.

Furthermore, according to another specific feature of the present invention, the management center controls the image playback via the video information display device. According to a more specific feature, when a nurse call is received but staff cannot immediately respond due to attending to other residents, the management center not only verbally conveys a request to wait but also initiates video playback via the video information display device to alleviate the resident's frustration. At that time, the management center can also switch the images to ensure that appropriate, pre-selected images are played. Such images may include not only images of residents but also images of management center staff responding to the nurse call, which can be stored in the video information display device and selected for playback. According to another specific feature, playback of the video information display device is controlled from the management center based on feedback from the resident's voice and facial expressions. Furthermore, the images displayed by the video information display device linked to the nurse call system may be videos, similar to other features of the present invention.

According to the features of the present invention described above, for example, a nursing home resident can view videos created from still images of themselves, family members, friends, etc., from their younger days when no video existed, using a video information display device placed in their room. Furthermore, according to another feature of the present invention, interactive communication with the viewer enables more appropriate display or creation of the video. These features are useful, for example, for promoting the physical and mental well-being of nursing home residents. Moreover, according to another feature of the present invention, the display of images is linked with the nurse call system to facilitate communication with residents.

The present invention, with the above features, provides a video information display device usable in nursing homes, for example, and is useful for promoting the physical and mental well-being of residents.

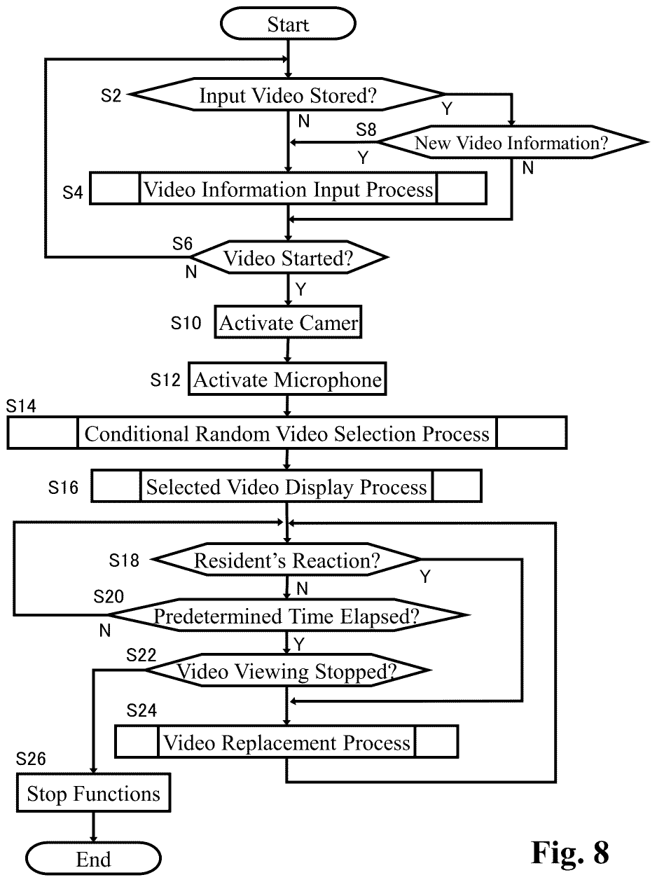

FIG. 8 is a basic flowchart illustrating the detailed functions of the smartphone controller 102 in Embodiment 4 of FIG. 4. This flowchart is achieved by executing a program stored in the memory unit 104. The flowchart in FIG. 8 aims to explain the details of a function that provides comfort to residents. This is achieved when a resident views a video displayed on display screen 116, specifically by modifying the video display based on feedback information from the resident's voice and facial expressions, thereby realizing pseudo-communication between the resident and the displayed video. Note that this function can be realized not only in Embodiment 4 but also using the corresponding configurations in Embodiments 1 to 3.

The flow in FIG. 8 begins when the video information display function is selected via operation at console 106, etc., on the smartphone 100 shown in FIG. 4. When the flow in FIG. 8 starts, step S2 checks whether input video information is stored in storage unit 104. Here, input video information refers to, for example, videos such as videos 122, 124, 126 in FIG. 5 created at image processing company 2. Step S2 thus checks whether such video information is stored in storage unit 104.

If storage of input video is not confirmed in step S2, the flow proceeds to step 4, wherein the video information input process is carried out. The process in step S4 involves acquiring the video information, assigning a video ID, and storing them in the storage unit 104. Details of the video information input process in step S4 will be described later. Upon completion of the video information input process in step S4, the flow moves to step S6. On the other hand, if any input video storage is confirmed in step S2, the flow proceeds to step S8 to check whether new video information is available. If new video information is available, the flow proceeds to step S4 to acquire that video information, assign an ID, store it in storage unit 104, and then proceed to step S6. If no new video information is available in step S8, the flow proceeds directly to step S6.

In step S6, the system checks whether a video viewing start has been instructed via operation at console 106 or similar means. If no such instruction exists, the flow returns to step S2. The steps from S2 to S8 are then repeated until a video viewing start is confirmed in step S6. Once a video viewing start instruction is confirmed in step S6, the flow proceeds to step S10.

In step S10, the camera 10 shown in FIG. 4 is activated, and the flow proceeds to step S12 to activate the microphone 108. This is to acquire feedback information, such as the resident's facial expressions and voice, while they view the video displayed on the display screen 116. The flow then proceeds to step S14 to perform conditional random video selection process. This selection processing is based on default choices but aims to avoid monotony and introduce an element of surprise.

Specifically, videos created using methods shown in FIGS. 5 to 7, based on portraits of the resident themselves or their close relatives such as family or friends, are prioritized as defaults. Additionally, the video the resident last watched is prioritized as a selection condition. Furthermore, neutral expressions close to a straight face are prioritized. While using such default videos as a base, random selections of expressions like smiles or angry faces are mixed in to create an element of surprise. Furthermore, the selected videos are fundamentally assigned an ID as a single unit, starting and ending with the same still image, as shown in FIGS. 6 and 7. This is to seamlessly connect and display different videos using the same still image. Note that the connected videos do not necessarily have to start and end with the same still image; this will be discussed later.

When a video is selected in step S14, the flow proceeds to step S16 to perform the selected video display process. The process in step S16 is fundamentally to start displaying the selected video. However, it also includes the functionality to process and start displaying the video as one that includes reverse playback, as shown in FIGS. 6 and 7, when a video like the one in FIG. 5 is selected. Furthermore, when such display processing including reverse playback is performed, a different video ID is assigned to the processed data and stored in storage unit 104 to reduce the burden during reuse. In other words, the processed data after such display processing including reverse playback is saved and treated as new video information in step S8.

Then, when the display of the selected video begins in step S16, the flow proceeds to step S18. In step S18, the resident's reaction is checked based on feedback information such as the resident's facial expressions and voice while viewing the video. This check includes not only detecting the presence or absence of a reaction, but also judging whether the reaction is pleasant, unpleasant, joyful, angry, etc. It also includes judging the specific nature of the reaction, such as distinguishing between “smile,” “sneer,” “forced smile,” and “roaring laughter,” even if the laughter is the same. Furthermore, it includes judging the directionality of the reaction, such as whether it is moving from a ‘smile’ towards “roaring laughter.” If no resident reaction is detected in step S18, the flow proceeds to step S20 to check whether a predetermined time has elapsed. If the predetermined time has not elapsed, the system returns to step S18 and repeats steps S18 and S20 until the predetermined time has passed.

If step S20 determines that the predetermined time has elapsed, the flow proceeds to step S22 to check whether a video viewing stop instruction has been issued via operation at the console 106 or similar means. If no viewing stop is detected in step S22, the flow proceeds to the video replacement process in step S24. On the other hand, if a resident reaction is detected in step S20, the flow directly proceeds to step S24. The video replacement process initiates the replacement and display of a different video, then returns to step S18. From step S18 to step S24 is repeated as long as no viewing stop instruction is detected in step S22. Conversely, if a viewing stop instruction is detected in step S22, the flow proceeds to step S26 to stop various functions. In step S26, other words, camera 110 and microphone 108 are stopped, video display on display screen 116 is also stopped, and the flow terminates.

Note that the video replacement process in step S24 performs replacement based on the resident's reaction when transitioning to step S24 via step S18. For example, when a video centered on a neutral expression is selected and displayed, if the system detects that the resident viewing it has smiled, it replaces it with a smiling video. This enables communication where residents initiate the transition from neutral expressions to smiling expressions. Conversely, when transitioning to step S24 via step S18, the replacement aims to elicit a resident's reaction through the video change. For example, if the resident's expression remains unchanged (e.g., neutral), the video is replaced with a smiling one to observe the resident's response. If the resident then smiles in turn, communication is established where the video leads, transforming neutral expressions into smiling ones. Details of this video replacement process in step S24 are described later.

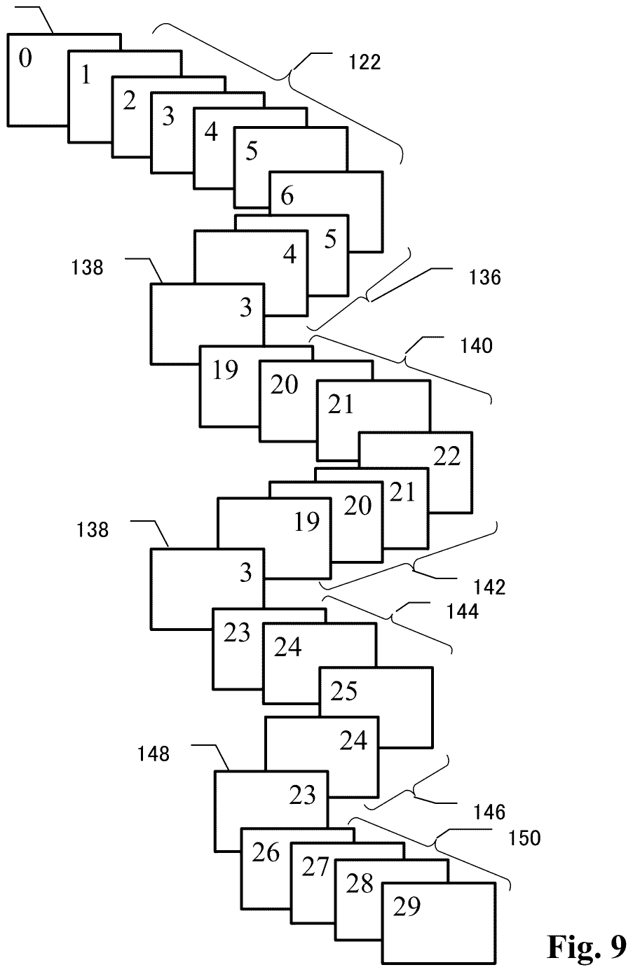

FIG. 9 is an explanatory diagram illustrating an example method, common to Embodiments 1 to 4, for seamlessly creating a longer video by connecting multiple different videos at the same static image section, similar to FIGS. 6 and 7. However, the methods in FIGS. 6 and 7 described creating multiple different videos based on the original still image 120 and then reversing them all back to the still image 120. In other words, they described cases where the still image 120 was always used to connect to another video. In contrast, FIG. 9 is intended to describe cases where another video is connected without necessarily using the original still image 120.

FIG. 9 also creates video 122 based on the original still image 120 and creates video 136 in the form of its reverse playback. However, the reverse playback is limited to still image 138, and a different video 140 is created based on this still image 138. Then, from video 140, video 142 is created in the form of its reverse playback back to still image 138.

Next, a different video 144 is created based on still image 138, and a video 146 representing the reverse playback of this video is created. However, the reverse playback is limited to still image 148, and a different video 150 is created based on this still image 148. Thus, using the method shown in FIG. 9, it is possible to create a varied, long video without necessarily returning to the original still image 120.

It is also possible to create a long video by continuously transforming and developing a single still image in one direction, without using the creation method of the present invention. However, since the original information is a single still image, excessive transformation risks creating a sense of incongruity or unnaturalness due to deviation from the original still image. The method in FIG. 9 prevents this by ensuring that, while it does not necessarily return to the original still image 120, it returns to a still image 138 close to the original still image or to the adjacent still image 148.

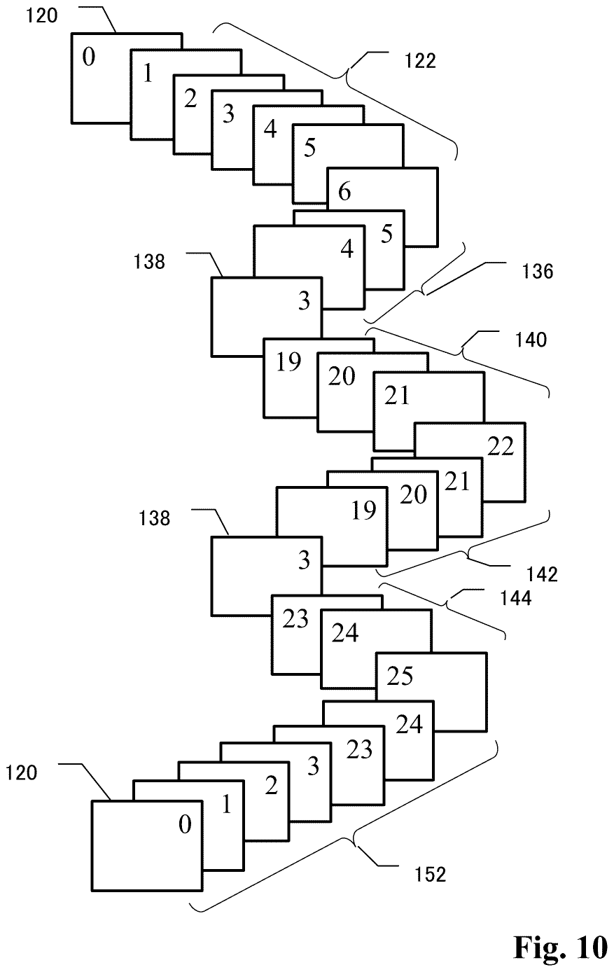

FIG. 10 is also an explanatory diagram showing an example method for seamlessly creating a longer video by connecting multiple different videos using the same static image portion. However, to address the points considered in FIG. 9 above, it periodically returns to the original static image. Specifically, FIG. 10 is identical to FIG. 9 up to videos 122, 136, 140, 142, and 144, but illustrates an example where it returns to the original video 120 during the reverse playback of video 144.

As described above, by appropriately combining the methods explained in FIGS. 5 through 7 and FIGS. 9 and 10, it is possible to create long videos that are varied yet remain faithful to the original video.

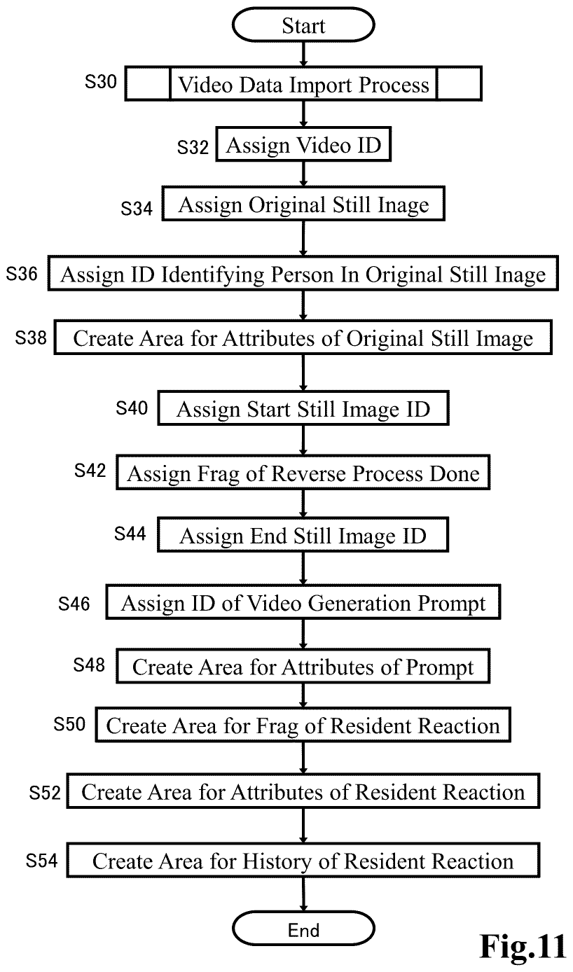

FIG. 11 is a flowchart detailing the video information input process at step S4 of the basic flowchart in FIG. 8. When the flow starts, step S30 performs the video data import process in which data of the target video is imported into memory 104. Next, step S32 assigns an ID to the imported video, and step S34 assigns the ID of the original still image from which the imported video was derived. This original still image ID corresponds, for example, to the still image 120 shown in FIGS. 6, 7, 9, and 10. It serves as the basis for playing a long video composed of different videos created from the same still image.

Furthermore, in step S36, such an ID is assigned that the ID identifies the individual who is the subject of the original still image. This serves as information for video replacement, as described later. Next, in step S38, an input area for the original still image's attributes is created. In this input area, attributes such as the relationship (e.g., whether the subject is the resident themselves, a family member, or a friend), gender, and the shooting date (which indicates the subject's age) can be freely entered as needed for the individual ID assigned in step 36.

Next, in step S40, an ID is assigned to the still image at the video's starting position. This still image ID may be the same as that of still image 120 shown in FIGS. 6, 7, 9, and 10 (starting still image ID is “0”), or it may be the ID of a still image created by modifying still image 120, such as still image 138 in FIG. 9 (starting still image ID is “3”) or still image 148 (starting still image ID is “23”).

Next, in step S42, a flag is added to indicate whether the video has undergone reverse playback processing. For example, if the video is one where the original still images are transformed in one direction, like video 122 in FIG. 5, the flag is “0”. On the other hand, if a video is managed as a single unit consisting of video 122 followed by its reverse playback video 128 in sequence, as shown in FIG. 6, the flag is set to “1”. Furthermore, in step S44, the ID of the still image at the video's end position is assigned. For example, for video 122 in FIG. 5 with flag ‘0’, the end still image ID is “6”. Conversely, in the sequence of video 122 and video 128 with flag “1” in FIG. 6, since it returns to the original still image 120, the ending still image ID is “0”. Furthermore, in the sequence of video 122 and video 136 with flag ‘1’ in FIG. 9, the ending still image ID is “3”.

The ID of the still image at the start position of a video, or the ID of the still image at the end position of a video, as described above, is used when seamlessly connecting multiple videos to form a longer video.

Furthermore, in step S46, the ID of the prompt used to create the video from the original still image is assigned. Then, in step S48, an attribute input field for that prompt is created. This input field allows free entry of attributes such as positive attributes (e.g., “Smile,” “Sarcastic Smile,” “Fake Smile,” “Burst of Laughter” note that “Sarcastic Smile” is also classified as a laughter attribute) or negative attributes (e.g., “Anger,” “Disappointment”). These prompt attributes and prompt IDs are used to manage video replacements.

Next, in step S50, an input field for a flag indicating whether a resident reacted is created. In step S52, an input area for the reaction attribute is created for cases where a resident reacted. This resident reaction attribute input field allows inputting whether the reaction was positive or negative. For example, positive attributes such as “smile,” “sneer,” “forced smile,” or “burst of laughter,” and negative attributes such as ‘anger’ or “disappointment” can be entered. The presence or absence of these resident reactions, their attributes, and their history are used to manage video replacement. Further, in step S54, an input field for reaction history of resident is created, and the flow goes to the end.

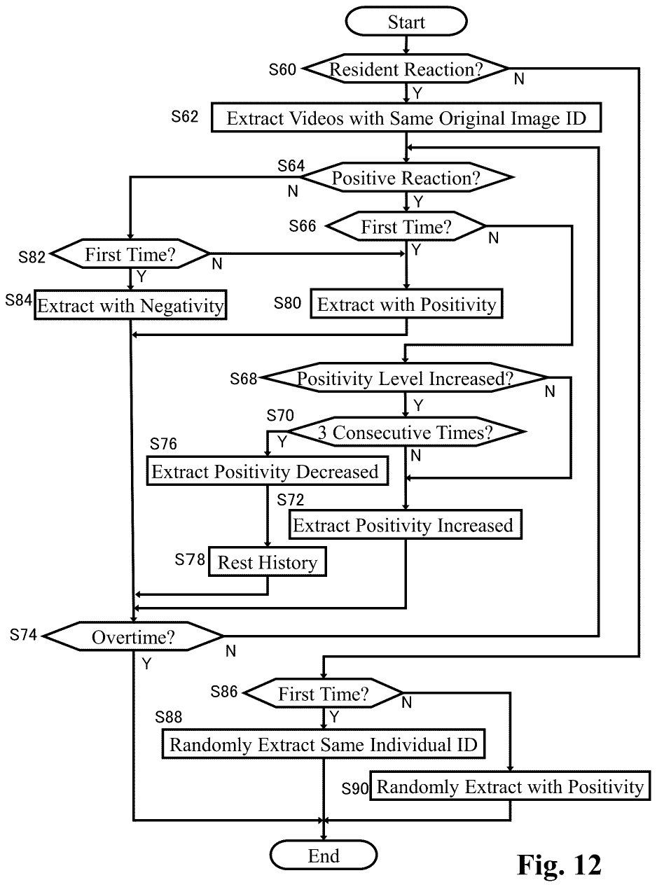

FIG. 12 is a flowchart detailing the video replacement processing shown in step S24 of the basic flowchart in FIG. 8. When the flow starts, step S60 checks whether the cause for entering video replacement processing was a resident reaction. If the video replacement process was initiated due to a resident's reaction, this corresponds to progressing from step S18 to step S24 in FIG. 8. In this case, the flow proceeds to step S62. The flow from step S62 illustrates a specific example of a function that provides comfort to residents by altering the displayed video based on their reaction, thereby achieving pseudo-communication between the resident and the displayed video.

In step S62, plurality of videos of identical original still image ID are first selected from the videos stored in memory unit 104. In other words, multiple different videos sharing the same original still image ID are extracted as replacement candidates in step S62. In this case, the original still image ID is selected randomly. Alternatively, the original still image ID may be selected based on certain conditions or weighting. It is assumed that a diverse range of videos are stored in storage unit 104. Consequently, the extracted video candidates will also include numerous videos sharing the same original still image ID, varying in degree from positive attributes to negative attributes.

Next, in step S64, it is checked whether the reaction was positive or not. If the reaction was positive, the flow proceeds to step S66, where it is checked based on the reaction history whether this positive reaction was the first occurrence. If it was not the first occurrence, this indicates that positive reactions have been repeated consecutively, so the flow proceeds to step S68 to check whether the positivity level increased during the consecutive reactions. Specifically, this includes cases such as when a “smile” changes to a distinct “laugh.” Then, the flow proceeds to step S70 to check whether the history shows an increase in positivity for three consecutive times. If the result shows fewer than three consecutive increases in positivity, the flow proceeds to step S72 to extract one video where the positive attribute was more strongly promoted, and the flow moves to step S74. The above flow means that the face in the video increases its degree of laughter in response to the resident increasing their degree of laughter. In other words, this flow achieves a pseudo-communication where the resident leads the movie. This allows the resident to have a pseudo-experience in which a person in the movie sympathizes with the resident.

On the other hand, when Step S68 determines that the history does not indicate an increase in positive sentiment, the flow proceeds to Step S72 to extract one video where the positive attribute was more strongly promoted, and the flow proceeds to Step S74. This process represents communication where the resident's level of laughter decreased, yet the video's level of laughter increased. This allows the resident to sense that the other person experienced different emotions than themselves. If replacing this video causes the resident to laugh again, it creates a simulated experience where the resident laughs in response to the video. In this case, the video leads the laughter in the communication. Conversely, it is also possible that replacing this video fails to elicit synchronization from the resident, who instead responds with a negative attribute. Therefore, unlike the monotonically increasing positive reactions via step S70, this scenario can create a simulated experience with a slightly tense atmosphere.

In contrast, when Step S70 detects that the number of consecutive increases in affirmation has reached the third occurrence, it transitions to Step S76 to extract a video with diminished positive attributes. This also represents a form of communication where the video ceases to synchronize with the resident's increasing laughter. This is a technique to break away from the unnatural monotony of only both parties' laughter increasing. This change creates communication where the video leads the resident. The flow then proceeds to step S78 to reset the sequence history and transitions to step S74.

Furthermore, if step S66 determines the positive reaction is the first occurrence, the flow proceeds to step S80, extracts one video with positive attributes, and transitions to step S74. In this case too, communication takes the form where the resident leads the laughter.

Unlike the above cases, if a positive reaction cannot be confirmed in step S64, it corresponds to the resident giving a negative reaction, so the flow proceeds to step S82. In step S82, it checks whether the negative reaction was the first occurrence. If it was the first occurrence, the flow proceeds to step S84, extracts one negative attribute video, and proceeds to step S74. In this case too, the communication takes the form of the resident leading negative emotions. However, this response is limited to the first instance. If the reaction in step S82 is not the first occurrence, the flow proceeds to step S80, extracts one positive attribute video, and proceeds to step S74. In this case, the system does not synchronize with the resident's negative reaction; instead, the video leads the interaction, eliciting a positive reaction to observe the situation. Thus, for negative reactions, the system avoids falling into a vicious cycle and proactively guides the resident.

In step S74, the system checks whether a predetermined time (e.g., 3 minutes) has elapsed since detecting the resident's reaction. If not, it returns to step S60. From step S60, the actions prepared in step S84 are repeated until the passage of the predetermined time is detected in step S74. When the predetermined time elapses in step S74, the flow terminates. That is, the video replacement process ends temporarily, and the flow returns to step S18 in FIG. 8. This allows the flow in FIG. 12 to restart from the beginning upon the next resident reaction, enabling extraction of a different set of videos based on another original still image in step S62.

As described above, when a resident's response is initially detected in step S60, the system limits the video replacement target to videos created from the same original still image ID in step S62 until step S74 determines that a predetermined time has elapsed. By attempting various forms of communication with the resident using videos within this scope, the system avoids becoming distracted in its response to the resident. On the other hand, when the passage of the predetermined time is detected in step S74, the flow in FIG. 12 terminates. This returns to step 18 in FIG. 8. When executing step S24 again, the flow can start from step S60 in FIG. 12. Consequently, in step S62, items possessing a new original still image ID will be extracted. In other words, restarting the flow in FIG. 12 corresponds to temporarily lifting the restriction to videos created from the same original still image. This broadens the range for extracting replacement videos, preventing monotony.

Meanwhile, if Step S60 in FIG. 12 confirms that the cause for entering the video replacement process was not a resident's reaction, the flow proceeds to Step S86. Here, the case where the video replacement process is entered without a resident reaction corresponds to the situation in FIG. 8 where the flow proceeds from step S18 to step S20, detects the passage of a predetermined time, and then, since no video viewing stop instruction is detected in step S22, transitions to step S24. The flow from step S86 in FIG. 12 in this case illustrates a specific example of inducing some reaction from the resident when no resident reaction is present. In other words, it concerns an attempt at pseudo-communication where the video lead elicits some reaction from the resident.

In step S86 of FIG. 12, the system checks whether this is the first time the resident has shown no reaction to the video replacement. If it is the first time, the flow proceeds to step S88. In step S88, one video is randomly selected from those with the same individual ID but different original still images, and the flow terminates. That is, if the lack of response is the first occurrence, the selection range is limited to videos with the same individual ID, attempting to elicit a resident's response within continuity.

On the other hand, if Step S86 in FIG. 12 detects that this is not the first time the resident showed no reaction to the video replacement, the flow proceeds to Step S90. In Step S90, without any further restrictions, one video with a positive attribute is randomly selected, and the flow ends. This is to stimulate the resident by broadening the selection range and extracting a video with a positive attribute, which is expected to be pleasant for the resident.

Regarding the response when it is confirmed in step S60 of FIG. 12 that the cause for entering the video replacement process was not the resident's reaction, the processing is not limited to steps S86 to S90. In other words, if it corresponds to an attempt at pseudo-communication where the video leads the resident to produce some kind of reaction, other processing may also be adopted.

Furthermore, the details of the video replacement processing diagram in step S24 of FIG. 8 are not limited to the flowchart shown in FIG. 12. In other words, for achieving the pseudo-communication where the resident leads the video or the pseudo-communication where the video leads the resident, the process shown in the flowchart of FIG. 12 may be entrusted to a generative AI.

0135

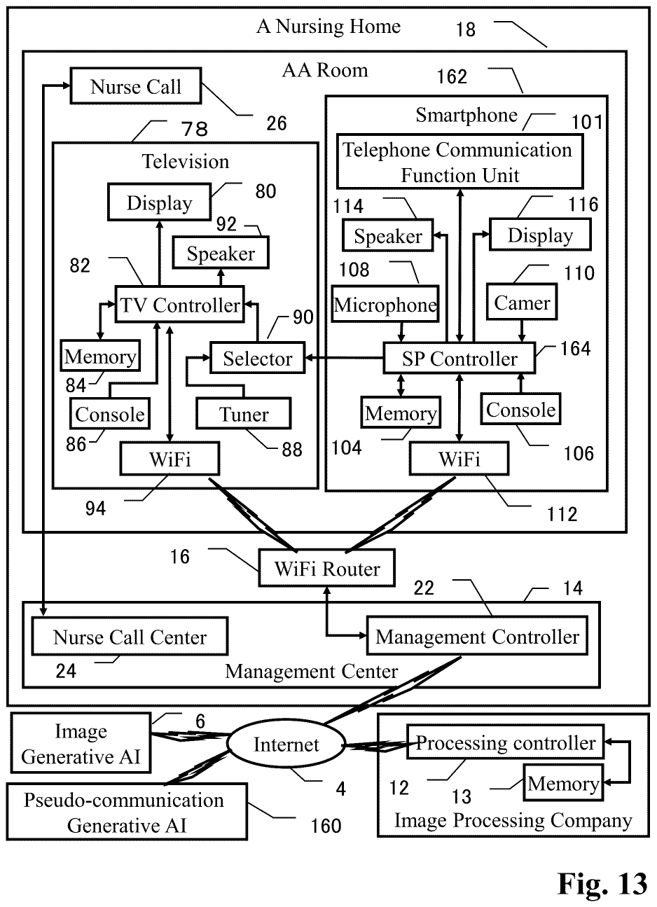

FIG. 13 is a block diagram showing the overall video information display system according to Embodiment 5 of the present invention. Embodiment 5 is common to Embodiment 4, except that the functions handled by the smartphone controller 102 in FIG. 4 of Embodiment 4 are now entrusted to the pseudo-communication generative AI 160 in an external cloud. Therefore, the smartphone 162 in FIG. 13 is common to the smartphone 100 in FIG. 4, except that the functions of the smartphone controller 164 are reduced. Since other aspects in FIG. 13 are common to FIG. 4, the same reference numbers are used for each part, and the description is omitted.

The pseudo-communication generative AI 160 in FIG. 13 connects to the smartphone's WiFi 112 via the management controller 22 of the management center 14 and a WiFi router, thereby collaborating with the smartphone controller 164. Through this linkage, the functions shown in FIGS. 8, 11, and 12, which were previously handled by the smartphone controller 102 in FIG. 4, are now handled by the pseudo-communication generative AI 160 in FIG. 13. However, the memory unit 104 of the smartphone 162 stores necessary data itself, optimizing efficiency through appropriate linkage with the pseudo-communication generative AI 160.

The pseudo-communication generative AI 160 is fundamentally a video generative AI, enabling video conversations with residents via the smartphone 162. Specifically, it displays and animates facial videos created from original still images on the display screen 116, while also generating voices through the speaker 114 to conduct conversations. Therefore, when voice samples of the person depicted in the original still image are available, the AI 160 learns from them to generate conversational speech. If the person in the original image is deceased, it generates simulated speech based on voice samples from family members or facial skeletal analysis, accounting for age differences.

Furthermore, to achieve pseudo-communication with residents, the conversation content is generated using a text generation function to produce speech that enables meaningful dialogue. Crucially, the most important aspect of the present invention is its response to resident reactions. Even for speech generation, information about the resident's pleasant or unpleasant emotions detected by microphone 108 and camera 110 is fed back into the generated text. This goes beyond simple context-based text generation, enabling the creation of responses attuned to the resident's underlying emotions.

Furthermore, feedback is provided not only on the text itself but also on the tone, volume, and speed when it is voiced, striving for a heartfelt response to the resident. Additionally, feedback is provided not only on words but also on the changes in facial expressions described in FIGS. 5 to 12 to respond to the resident. Furthermore, since this response utilizes generative AI beyond predefined flowcharts, it enables more diverse pseudo-communication while also allowing responses to evolve spontaneously. Feedback on changes in the resident's facial expressions is also useful as information for this evolution, enabling pseudo-communication that better aligns with the resident's feelings.

The pseudo-communication generative AI 160 of Embodiment 5 in FIG. 13 also acquires the semantic content of the language uttered by the resident, as captured by microphone 108, as feedback information from the resident. That is, it treats not only emotional information derived from expressions or voice tone, but also the objective semantic content of the language as feedback information. For example, the language “happy” is logically positive feedback from the resident, while the language ‘bored’ is logically negative feedback. However, when processing this information, it performs a double-check using not only the objective linguistic information but also information from facial expressions and voice tone. Therefore, even if the resident says “happy” verbally, if their expression is gloomy, it scrutinizes whether the words are taken at face value. Learning from accumulated conversations enables such scrutiny.

As described above, Embodiment 5 in FIG. 13 provides feedback on the resident's facial expression changes corresponding to the video when utilizing the video generative AI. This enables more flexible realization of pseudo-communication where either the resident leads the video or the video leads the resident.

The implementation of the various features of the present invention is not limited to the examples described above; various modifications are possible. For example, in Embodiment 5 of FIG. 13, the pseudo-communication function is entrusted to the external cloud-based pseudo-communication generative AI 160. However, the use of generative AI is not limited to such external cloud AI. For example, pseudo-communication could be achieved using a local generative AI installed within the nursing home 8 (e.g., installed within the management center 14 in FIG. 1 as a function of the management controller 22). In this case, it is also possible to exchange information with the external cloud generative AI as appropriate for the evolution of the local generative AI. For example, prompts generated by the local AI could request information generation from the external cloud AI, with the resulting information then incorporated into the local AI's knowledge base.

Furthermore, the smartphone controller 164 of the smartphone 162 may be equipped with a generative AI function to achieve pseudo-communication. In this case, for the evolution of the generative AI function in the smartphone controller 164, it may be possible to exchange information as appropriate with either external cloud-based generative AI or the locally generated AI installed within the nursing home 8. For example, prompts generated by the smartphone controller 164's AI generation function may be used to request information generation from an external cloud-based AI or a local AI installed within the nursing home 8, and this generated information may be incorporated as data for the smartphone controller 164's AI generation function.

As apparent from the above, the present invention provides a video information display device usable, for example, in nursing homes, enabling video display control tailored to residents watching videos.

What is claimed is:

1. A video information display device comprising:
a storage unit for video information;
a control unit for controlling playback of the video information in the storage unit;
a display for displaying the video information based on the control unit; and
feedback acquisition unit for acquiring feedback information from a viewer of the video,
wherein the control unit controls playback of the video information based on the viewer's feedback information acquired by the feedback acquisition unit.

2. The video information display device according to claim 1, wherein the control unit continues playback while controlling it based on the viewer's feedback information acquired by the feedback acquisition unit after video playback has started.

3. The video information display device according to claim 1, wherein the control unit determines the viewer's pleasantness or unpleasantness based on the viewer's feedback information acquired by the feedback acquisition unit and controls playback based on the determination of the viewer's pleasantness or unpleasantness.

4. The video information display device according to claim 3, wherein the control unit controls the playback of the video information to demote the determination of the viewer's pleasantness or unpleasantness when the feedback acquisition unit has performed the determination.

5. The video information display device according to claim 3, wherein the control unit controls the playback of the video information to promote the determination of the viewer's pleasantness or unpleasantness when the feedback acquisition unit has performed the determination.

6. The video information display device according to claim 3, wherein the control unit controls the playback of the video information in the manner to lead the viewer and elicit a reaction when the feedback acquisition unit fails to detect reaction from the viewer.

7. The video information display device according to claim 3, wherein the control unit controls the playback of the video information to lead the viewer toward positive emotions in response to any of viewer's pleasantness or unpleasantness.

8. The video information display device according to claim 1, wherein the video information is provided with association information.

9. The video information display device according to claim 8, wherein the association information is information about the original image from which the video generated.

10. The video information display device according to claim 8, wherein the association information is information identifying individuals appearing in the video.

11. The video information display device according to claim 8, wherein the association information is information regarding pleasant or unpleasant states associated with the video.

12. The video information display device according to claim 8, wherein the associated information is information related to the viewer's reaction history to that video.

13. The video information display device according to claim 8, wherein the video is a video generated by a prompt-based generative AI, and the associated information is information related to the prompt used for generation.

14. The video information display device according to claim 1, wherein the control unit is the generative AI.

15. The video information display device according to claim 14, wherein the generative AI generates response information based on words uttered by the viewer of the video and modifies the response information based on feedback information of the viewer's pleasant or unpleasant facial expressions.

16. The video information display device according to claim 1, wherein the feedback acquisition unit is a microphone, and the feedback information is the content of words uttered by the viewer.

17. The video information display device according to claim 1, wherein the feedback acquisition unit is a microphone, and the feedback information is the tone of the viewer's voice.

18. The video information display device according to claim 1, wherein the feedback acquisition unit is a camera, and the feedback information is the viewer's facial expression.

19. A video information display device comprising:
generative AI for controlling video playback; and
a display for displaying the video playback based on the control of the generative AI,
wherein the generative AI controls the video playback based on feedback information of a viewer's facial expressions indicating pleasure or displeasure of the viewer viewing the video playback on the display.

20. A video information display device comprising:
generative AI for controlling video playback; and
a display for displaying the video playback based on the control of the generative AI,
wherein the generative AI generates response information to words of a viewer viewing the video playback on the display and modifies the response information based on feedback information of the viewer's facial expressions indicating pleasure or displeasure of the viewer.
